(19) United States
(12) Patent Application Publication
(10) Pub. No.: US 2016/0358195 A1
(43) Pub. Date: Dec. 8, 2016

(54) Method To Generate A Consumer Interest Spatial Map, Based On Data Collected From The Movements Of Multiple Devices In A Defined Location

(71) Applicant: Media4Shoppers sp. z o. o., Lublin (PL)

(72) Inventor: Tomasz Klaczkow, Warszawa (PL)

(73) Assignee: Media4Shoppers sp. z o. o., Lublin (PL)

(21) Appl. No.: 15/177,246

(22) Filed: Jun. 8, 2016

Related U.S. Application Data
(60) Provisional application No. 62/172,628, filed on Jun. 8, 2015.

(51) Int. Cl. G06Q 30/02

(52) U.S. Cl. CPC G06Q 30/0205

(57) ABSTRACT

A method and system to build a spatial map for a defined location based on the data collected from moving devices to define, measure and categorize the space in any consumer based environment and optimize the location of goods in the defined area. A method and system to collect, store, compare and display the real time positioning data and comparison of emotional and rational decisions, timeframes, biometric data crossed with a store cashier system to verify a purchase decision allowing for the categorization of “heat points” on the spatial map. Also provided is a method that operates in wireless environments.

### RELATED APPLICATIONS

This application claims priority to U.S. Provisional Application Ser. No. 62/172,628 filed Jun. 8, 2015 entitled Happy Trolley Shopper Navigator, which is hereby incorporated herein by reference in its entirety.

### THE BACKGROUND OF THE INVENTION

The physical location of items, products, or users is critical to efficient and effective store management. This can be achieved using a spatial map. In general, a spatial map is a collection of points or objects displayed simultaneously on a viewing device or on another media. However, existing systems do very little to position the movements of multiple devices in a defined location, especially in covered areas (under one roof) and in real time.

Current methods for collecting consumer feedback about the value of the in-store space and product interest are dominated by traditional research methods: based on post-shopping interviews, execution of various shopping trip scenarios, etc. These methods include shopper interviews where the feedback and answers are not representative, because they may be given on a declarative basis. Product interest data, on the other hand, is collected mainly from a cashier system (purchase tracking), however the existing methods rarely describe the level of the consumer's rational or emotional interest for purchase. Also, non-purchased items require an analysis about the reasons for rejecting a purchase, this can not be addressed with purchase tracking.

Effective usage of the in-store space and presentation of the product are critical tools used to generate a purchase decision and increase store profits. Each decision consists of two elements (rational and emotional) but there is a lack of measurements, or methods to determine which of these two factors is more critical than the other. For many years, the shopper marketing industry has been trying to evaluate and aggregate many factors: emotional, rational, time frame, biometric sensors into one coherent method or, preferably, a spatial map of consumer interest. A map which will be based on facts—a defined algorithm and hard data—not hypothetical declarations.

The problem of in-location advertising, promotions and marketing, generally lies in their costs optimization, identifying the level of the consumer's attention and reaction, ideally leading to a purchase. Ad campaigns in mass media (TV, radio, press, outdoor, internet) have clear indicators and methods to verify their effectiveness, such as telemetry, CPP, CPT, reach etc. In-store ad campaigns should be measured by costs versus factors like: the space they consume, and the emotional, or rational reaction to them. One of the most important factors to evaluate the effectiveness of anb in-store advertising campaign, is the number of consumers who were exposed and the number of items being purchased. These type of analyses are missing.

Profiling of an advertisement is the key indicator that shopper marketers aim for. Despite the various methods and techniques available for the ATL marketing, the shopper marketing industry is still looking for more effective, more targeted advertising which—and this is most important factor—delivers a content in real time and during the purchase visit. Mobile advertising sometimes works well, but this content needs a prior approval of the mobile phone user. Consumer interest spatial maps, based on data collected from the movements of shoppers in the retail location would provide the ability to deliver highly profiled content during the shopping visit when the purchase decision has the highest probability to happen.

### PRESENT STATE OF THE TECHNOLOGY

Beacon based location system and other in-store positioning systems have become more popular, although there are still many problems related to them, such as: short-range NFC ranges, the requirement of additional antennas, big reflections and noise level in radio communication due the high level of equipment and electromagnetic field interferences.

There is no other application available on the market that offers the ability to create a spatial map of a location, while marking the marketing value of the particular location and displaying the consumers' purchase decision path based on continuous, non interfering observation of the space.

The use of biometric sensors is valued data and is popular for fitness activities and healthcare, but has never been used in the monitoring of shopping behavior for measuring the effectiveness of marketing activities and their receptivity by consumers, in real time and directly at a defined location.

### BRIEF SUMMARY OF THE INVENTION

The invention describes the method to collect and process data that results in a spatial map of the location showing the variable reactions, including purchasing decision, and general behavior of the consumers, and resulting in the estimation of the merchandising value of the space and other data for further analysis and optimisation of product location in a facility. The spatial map can be generated out of a single shopper's experience (single use—detailed observation) or as an average of multiple shoppers in a particular timeframe, including live updated data showing current measurements. The data can also be used for other purposes, such as real time promotions, shelve arrangement, price updates, etc.

The invention consist of two major aspects:

1. Use of the equipment for data collection, transmission and aggregation.

2. The method to process data in order to create a spatial map, to extract the data and present it in an attractive form, easy to extend and analyze.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a view of a flat area map according to the present invention.

FIG. 2 is a view of a floor plan according to the present invention.

FIG. 3 is a flow chart of a process of the present invention.

### DETAILED DESCRIPTION OF THE INVENTION

The method is based on the research of “HAPPY TROLLEY SHOPPER NAVIGATOR” (US provisional patent application US 62/172,628) and based on the 3rd item of the described invention—“Shopping marketing research” and partially on the functionality described in 1st item of the invention mentioned: “A device equipped with a unique software application”. The described method explores a single aspect of the applied non-provisional patent: the ability to generate a spatial map based on the data collected from devices to optimize the location and value based upon location, of goods in the store. The invention described below extends the idea to cover the general algorithm used to collect and aggregate the data that can be applied in other, similar scenarios.

### Studied Space

The studied space should be a single location—understood as closed area or space, such as supermarket floor, shopping mall corridors, storage, open space office, or other publicly available facility. The space is limited by the location's natural boundaries (walls, corridors, handrails, shelves, stands) and the range of the positioning system.

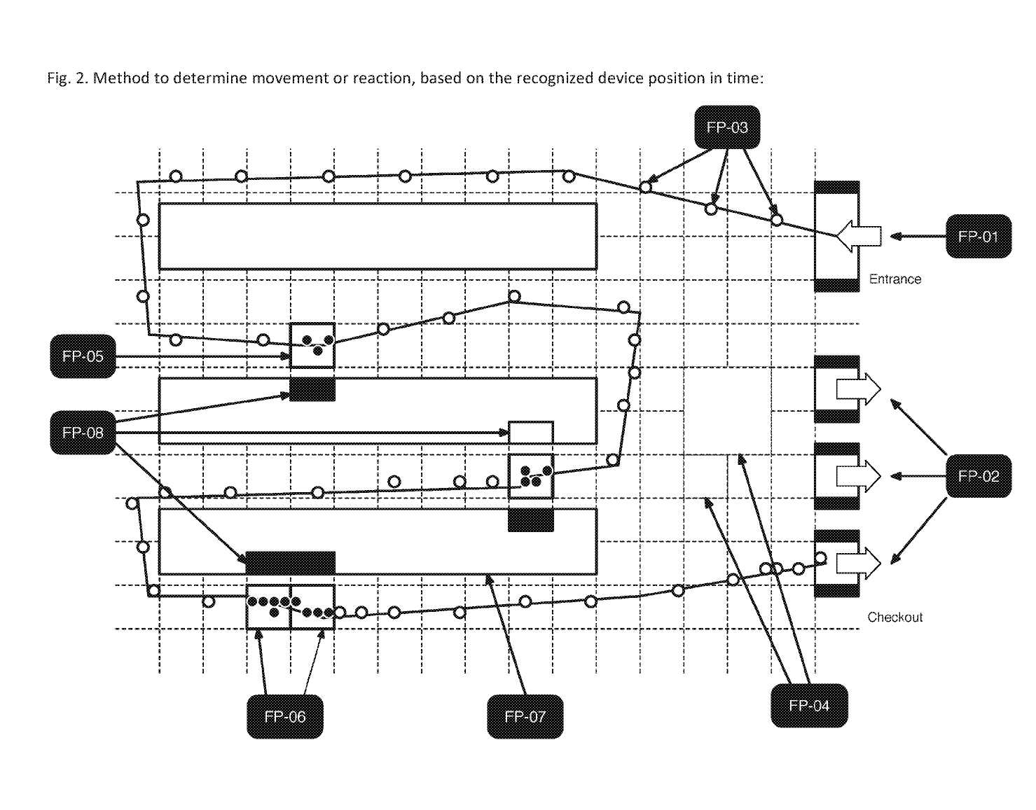

The space is modeled in an electronic form, where all boundaries and equipment can be mapped (such as shelves—as displayed on FIG. 2. FP-07), determining the accessible observation area. The spatial measurements can be taken in 3D (full spatial model) or 2D (flat spatial model) depending on the location, accuracy of the positioning system and analytical needs.

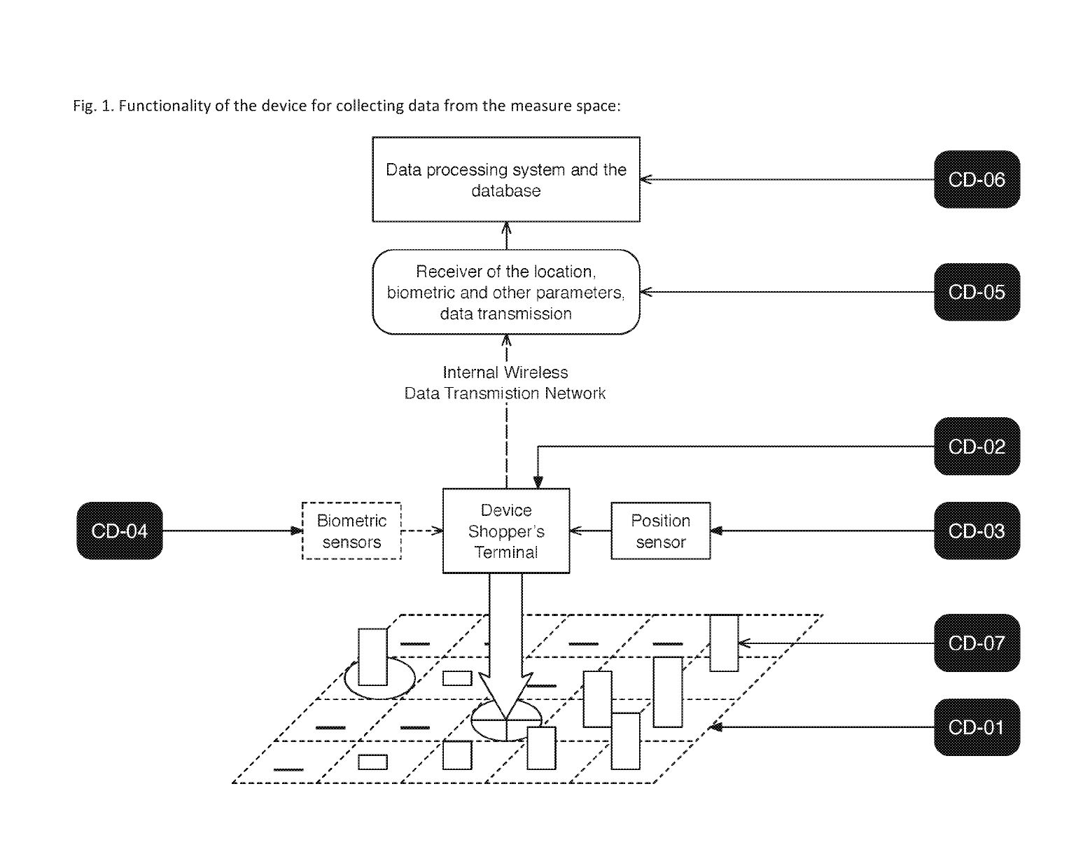

The space is divided into sections. Refer to FIG. 1. CD-01 as the example of 2D flat area map. Sections may be rectangular (2D) or cubic (3D)—but may also have adaptable sizes and shapes, adjusted to the floor plan (as shown FIG. 2. FP-04) and positioning accuracy. The minimal section size is determined by the accuracy of the positioning system.

Collecting Data from a Device or Devices

To infer a consumer's behavior and reactions it is essential to at least detect his or her position within the observed space. The method described is not limited to any specific position detection methods, but it assumes that the consumer will be equipped with a device or devices during the shopping experience, which allows for the collection of the required data.

The required device is considered an electronic terminal with computing abilities (ref. FIG. 1. CD-2). There are a number of devices that could be used for this purpose, such as:
A consumer mobile phone, smartphone, tablet, and/or smartwatch with dedicated software installed;
A proprietary, dedicated electronic terminal, attached to a cart or basket, or detachable wrist band, clasp band, bracelet, clip, brooch etc.;
The shopping cart or basket itself, equipped with an appropriate computing device;
An electronic shopping assistant;
Any other electronic equipment or device that can be associated with the shopper, the shopping cart, or the shopping basket;

From a psychological point of view, the working device should not affect the result of the shopping experience, nor suggest an impression to the consumer that they are being tracked during the whole shopping experience.

The device must be equipped with a position sensor (Ref. FIG. 1. CD-03), that enables the system to determine, within a desired precision, where the device is located within the observed space. The method does not dictate the exact technology to achieve that goal, but rather points to few known current techniques such as:
A radio frequency beacon (such as one based on Bluetooth technology);
Triangulation;
Nearest hot spot signal;
Using RFID tags to detect passing the particular area;
The use of pattern recognition, optical color recognition, barcode and QR code scanners;
Other methods of position reading not yet determined at the present state of the technology ;

The selected positioning method reads the position of the device associated with the shopper, every specified amount of time (TC). The TC factor is known to the whole system, it is fixed on the device and controlled by the device's internal timer. As time goes by, the position of the device is read in cycles determined by the TC (as shown on FIG. 2. FP-03, each dot represents a position determined in the subsequent cycles, named probes).

### Data Transmission

The device or devices must be capable of connecting to a WDN—Wireless Data Network (FIG. 1. CD-05), used to capture signals and data transmitted to the DPS—Data Processing System (FIG. 1. CD-06).

The most common application of the method may use protected wireless WiFi access points and network equipment to connect to the server using HTTP web services to deliver the collected data in chunks, but it is not limited to this transmission technology, as any method for transmitting data in a secured manner, upstream to the central system, is acceptable and valid.

The data should be transmitted continuously, with an option to failover in case of a lost connection and missing confirmation of the data reception from DPS. The data transmitted from the terminal devices is collected in the database for future use and further analysis. The device must be able to maintain some historical data, in order to optimize transmission and protect data from unexpected conditions. It is suggested, but not obligatory, that a lossless compression algorithm be used for transmission.

### The Shopping Session

The data is collected in sessions reflecting the shopper profile and preferences in a single process from the moment he or she enters the observed area (FIG. 2. FP-01) until he or she performs a checkout at the registers (FIG. 2. FP-02).

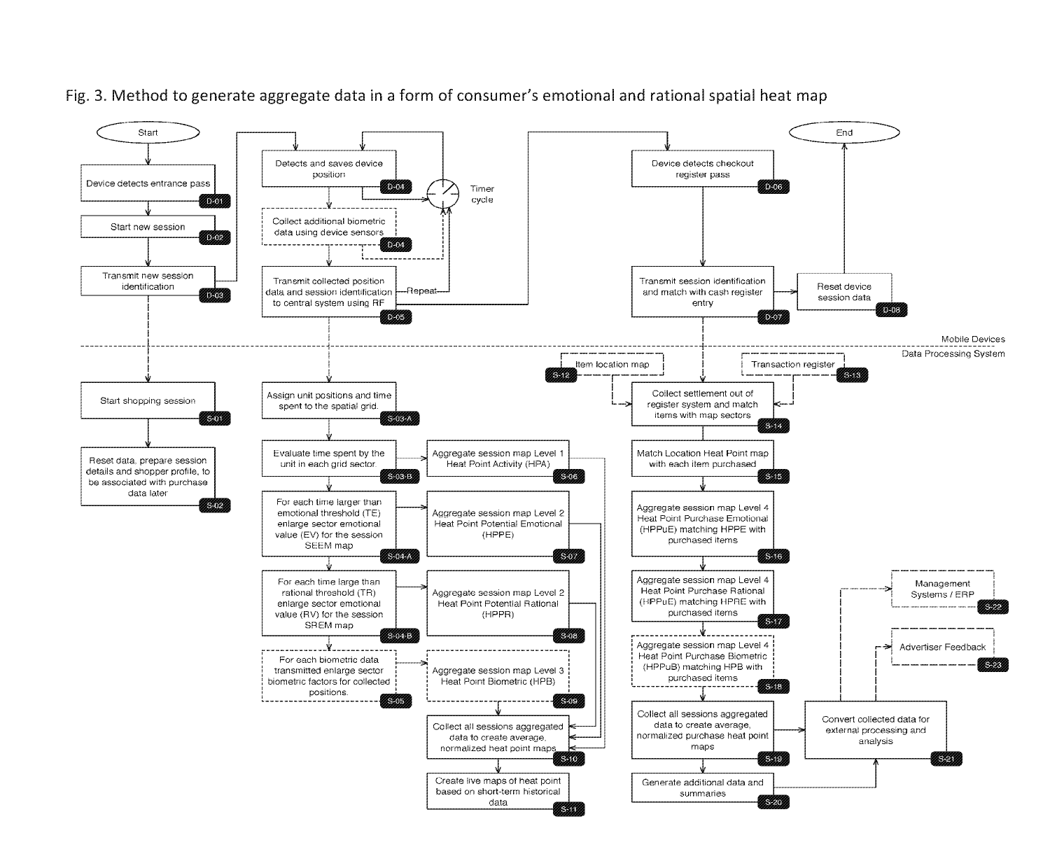

When the device passes the entrance gate to the space (ref. FIG. 3. D-01) the session starts with a data reset (ref. FIG. 3. D-02) and the creation of a unique identification used to determine the device and particular consumer over the whole observation timeframe.

The beginning of the session is transmitted over the WDN data network, so the DPS can initialize its own data structures (FIG. 3. S-01) and reset shopper counters for data collection and aggregation (FIG. 3. S-02). Each session DPS is associated with a single consumer profile and is a subject of observation. The exact time of the session beginning can be determined in order to provide valued information such as average time spent in an observed area per session and match this with other profile data;

The session ends with the passing of the checkout area (FIG. 3. D-06), determined by the position sensors (FIG. 2 FP-02). The device transmits the end of session to the DPS over WDN (FIG. 3. D-07) and resets its internal data to avoid any data theft (FIG. 3. D-08).

### Use of Positioning Data to Create Potential Heat Point Map

The position of the device must be precisely determined, with accuracy that enables location to the exact section of the spatial map. Each TC cycle, the device determines the section of the map where it is, at that moment, and keeps it in an internal cache (Ref. FIG. 3. D-04).

The collected data of the positions stored inside the device are captured and transmitted in chunks to the DPS. The amount of data is related to the TC cycle, as this can be too low to process and transmit every position taken, data should be prioritized, sorted and assigned to the session and sector on the device, prior to collection.

Use of Optional Biometric Data Collected from the Sensors

Optional biometric data can be collected during the session and summarized with position data (FIG. 1. CD-04) in order to deliver precise emotional reactions. This process is not obligatory and optional, depending on the method application.

Multiple devices can be used for the same purpose as long as they're connected with the same session and purchase decision, so the biometric sensors can be a part of the device or a separate unit or units, paired with the device over the session (e.g. a smart watch can collect heart rate and temperature and the device can compose that data with positioning).

Any change of parameters can be considered as the emotional reaction, and the exact weight of that measurements for the final map is a subject of system calibration.

The biometric data is composed with the position sensor and delivered continuously (FIG. 3. D-04), together with position and timing data. To determine the moment of reaction, the base level of the sensor data is determined at the beginning of the session. Any pick change of values is spotted and treated as a potential emotional reaction. The flat change of the parameter is considered as neutral, as the body parameters may change over time naturally, to become a new base level and reference value.

### Data Aggregation

The position is determined continuously, in a fixed period of time, and equal pace (FIG. 3. S-03-A). It is possible to detect if the device and customer associated to session remain in a certain section of the spatial map for the time of n-th multiplicity of the TC parameter (FIG. 3. S-03-B).

For the system, there are two global parameters defined, depending on the application and precision of the measurements:
TE—Threshold of emotional reaction, defined as the number of TC cycles, when remaining in the same section, that should be counted as an emotional reaction of the observed consumer for the environmental stimulus; This time can be associated with the reaction and perception time of something that consumers find interesting;
TR—Threshold or rational reaction, defined as the number of TC cycles, when remaining in the same section, that should be counted as a rational reaction and conscious consideration of the product purchase. From its nature TR is always greater than TE, as rational behavior requires reflection and time to digest. The TR factor may also indicate hesitation and considering product alternatives. (TR>TE)

The algorithm determines if the currently collected session position data changes match with the TE or TR parameters, in order to enlarge value of the sector, where the user stops or moves indeterminately (out of accuracy and or inside the sector boundary). Each session data contains a map of sectors with associated values expressed as a number of events when TE or TR thresholds limits were exceeded during the observation, respectively named Session Emotional Event Map (SEEM) and Session Rational Event Map (SREM). For an exemple of the method, refer to FIG. 2. In this case, the TE limit was set to 2 TC cycles (this parameter is a subject of the system calibration). The sector marked on the map as FP-05, is an example of the sector where the event took place, and thus, this sector's SEEM map emotional value (EV) was increased (FIG. 3. S-04-A), as other sectors where subsequent measurements passed the TE limit. Similarly, the sectors marked as FP-06 display the area where subsequent measurements passed the TR limit, and thus, the values in the SREM map rational value (RV) were increased (FIG. 3. S-05-B).

Merging session data within one summary is a subject of the data aggregation, in order to achieve a final form of the data output. The summary must take under consideration a particular period of time (timeframe), based on the observation period and minimal accuracy of the system, which depends on the average transmission pace. The latest data measured can be extracted and presented as the live preview of the spatial map.

The first aggregation (FIG. 3. S-06) summarizes the number of points of presence, in the time frame of all sessions, for each sector on a spatial grid (FIG. 3. S-03-B). The position data that are collected, are normalized to match the highest and lowest values of the area to generate Level 1 map—Heat Point Activity (HPA) map. The map consists of a value for each sector, based on number of spotted points. The map shows how the section is active, exposing the most trafficked and occupied area in the overall observed space (FIG. 1. CD-07).

Analogous maps can be created out of the data collected for SEEM and SREM (FIG. 3 S-08) data. The emotional value (EV) of the sector is calculated as a sum of all EV values in the determined timeframe, to generate a normalized Level 2 map—Heat Point Potential Emotional (HPPE) map. The map spots areas where consumers reacted in an emotional way, which can be used for evaluation of the space advertising and exposition feedback.

The rational value (RV) of the sector is calculated as a sum of all RV values in the determined timeframe, in order to generate a normalized Level 2 map—Heat Point Potential Rational (HPPR). The map is an overview of areas where consumers prefer rational decisions, considering a choice and consciously comparing and selecting items.

When the system uses optional biometric sensors, similarly for each sensor parameter, the value of the sector should be raised in case of a rapid change of the value. Maps for such events can be created respectively for each session (FIG. 3. S-05), and summarized as aggregated data, over the time frame generating (FIG. 3. S-09) Level 3 map—Heat Point Biometric (HPB) maps. The data is aggregated together with emotional Level 2 maps of HPPE and HPPR.

### Use of Calculation Capabilities of the Device

The method does not determine where the calculations take place, although it is suggested that in order to limit the size of data transmitted from the device to the system, at least some calculations should be made inside the device. The algorithm described on FIG. 3. distinguishes all calculations to be performed inside the data processing system (DPS), but those related to single session data may take place earlier on the device, to optimize the process and data throughput, and load balance computations across multiple devices.

Integration with Checkout and Purchase Decisions

In order to make the observations more accurate and detailed, and to provide feedback about the positions of goods and their presentation, the aggregated data must be compared with the final purchase decisions of the customer to determine the reason and behavior related to the selection.

Matching between session and register checkout settlement is used to identify products purchased (selected) by the consumer (FIG. 3. S-13).

When the device passes the checkout registers (ref. FIG. 2. FP-02), which can be detected by the positioning system, the data from checkout can be attached to the session data.

Based on the database of products and their locations, compiled with the checkout entries, related sectors (FIG. 3. S-12) where purchase took place can be detected (FIG. 2. FP-08) and compiled (FIG. 3. S-14).

These locations can now be crossed with the location of emotional (HPPE) and rational (HPPR) maps in order to find how long the consumer stayed in a location to make a final purchase decision. If the sector EV and purchased item matches, it enlarges the Emotional Purchase Value (EPuV) which can be summarized on Level 4—Heat Point Purchase Emotional (HPPuE) map (FIG. 3. S-16). If the sector RV and purchased item matches than it enlarges the Rational Purchase Value (RPuV) of the sector, which is summarized on Level 4—Heat Point Purchase Rational (HPPuR) map (FIG. 3. S-17). The value of both output maps is used to determine how much the location of the product is related to the emotional or rational behavior of consumer.

The optional biometric data can be aggregated and crossed with the Purchase decisions, and summarized as shown on FIG. 3. S-18, resulting in a summarized Level 4—Haet Point Purchase Biometric (HPPuB) data for each observed parameter.

The system may also collect and extract a number of side data (FIG. 3. S-20), not related to the spatial map of the examined space; such as the number of sessions (and rejection ratio, where a potential buys nothing), the average time spent in a space, and how it influences the final purchase value, among others. The way the data is collected in the method does not limit potential future applications.

### Sharing, Extraction and Visualisation of the Data

The method also establishes a process (FIG. 3. S-21) for converting calculated data into various forms, where they can be composed, extracted and used by internal management ERP systems, supporting decisions about product allocation and space optimization (FIG. 3. S-22) as well as providing feedback for advertisement campaigns and the effectiveness of merchandise promotional activities (FIG. 3. S-23).

In FIG. 3 there are the following boxes/segments:

Start

D-01: Device detects entrance pass

D-02: Start new session

D-03: Transmit new session identification

D-04: Detects and saves device position

D-04: Collect additional biometric data using device sensors

D-05: Transmit collected position data and session identification to central system using RF

Timer cycle

D-06: Device detects checkout register pass

D-07: Transmit session identification and match with cash register entry

D-08: Reset device session data

End

S-01: Start shopping session

S-02: Reset data, prepare session details and shopper profile, to be associated with purchase data later

S-03-A: Assign unit positions and time spent to the spatial grid

S-03-B: Evaluate time spent by the unit in each grid sector

S-04-A: For each time larger than emotional threshold (TE) enlarge sector emotional

value (EV) for the session SEEM map

S-04-B: For each time large than rational threshold (TR) enlarge sector emotional value (RV) for the session SREM map

S-05: For each biometric data transmitted enlarge sector biometric factors for collected positions

S-06: Aggregate session map Level 1 Heat Point Activity (HPA)

S-07: Aggregate session map Level 2 Heat Point Potential Emotional

S-08: Aggregate session map Level 2 Heat Point Potential Rational (HPPR)

S-09: Aggregate session map Level 3 Heat Point Biometric (HPB)

S-10: Collect all sessions aggregated data to create average, normalized heat point maps

S-11: Create live maps of heat point based on short-term historical data

S-12: Item location map

S-13: Transaction register

S-14: Collect settlement out of register system and match items with map sectors

S-15: Match Location Heat Point map with each item purchased

S-16: Aggregate session map Level 4 Heat Point Purchase Emotional (HPPuE) matching HPPE with purchased items

S-17: Aggregate session map Level 4 Heat Point Purchase Rational (HPPuE) matching HPRE with purchased items

S-18: Aggregate session map Level 4 Heat Point Purchase Biometric (HPPuB) matching HPB with purchased items

S-19: Collect all sessions aggregated data to create average, normalized purchase heat point maps

S-20: Generate additional data and summaries

S-21: Convert collected data for external processing and analysis

S-22: Management Systems/ERP

S-23: Advertiser Feedback

Mobile devices/ Data Processing System

### Possible Application of the Invention

Main target groups are retail stores, food and semi-food supermarket chains, DIY stores, hardware and tools, outdoor stores, with an exposition floor area above 1,000 sq m or 10,000 sq feet.

Analysis & Reports give a supermarket a powerful tool to measure marketing expenditures per shopper and optimize product categories advertising expenditures, including POSM distribution and costs.

Direct application of the generated heat maps:
Optimization of in store product location, its price and display,
Optimization of customer exploration space, to enlarge sales turnover,
Calculation of the value of the exposition space,
A measure of the influence of the product display to the purchase decision,
Insight into the consumer interests related to the product purchase decisions.

Direct application of the live collected data:
Immediate reaction to events in the observed space, such a traffic control, immediate promotions
Price optimization based on the consumer decision (floating prices),
Avoid congestions and traffic in critical locations

Derived applications:
Analysis of the shoppers behavior, paths and performance of the arrangement,
Feedback to advertisers, about the product purchase decisions and related consumer behavior,
Measuring marchandise effectiveness and value of location in the space,
Measuring the feedback of advertising campaigns.

A system based on this method may deliver knowledge about: shopper behavior & modes; variety of shopping paths; products categories avg. time visit total, per category; marketing costs per shopper and create a psychological model of the consumer population.

The method can also be used to direct live advertisement campaigns for shopping cart assistants, to deliver valued advertisement content based on the shopper's behavior.

1. Discovering shopper perception zones and collecting them as the emotional heat point spatial map, using the in-store positioning method. Use of the device or devices to collect customer's location, its changes in time and time spent at a particular position to collect, transmit and analyze that data, using the method and get a spatial heat map of the location from measurements of potential emotional and rational reactions, emotional and rational purchase decision locations, based on single or multiple observations collected in the timeframe.

2. Enrich the emotional factor and increase the accuracy of the collected perception data with any combination of heart-rate monitor, moisture sensor, eye movement, brain activity and other biometric sensors. Optional use of device or devices sensor(s), that enable the measurement of heart rate, body temperature, skin moisture, eye movement, brain activity or any other biometric parameter of the consumer that reflects his or her emotional reaction, to enrich data collected to generate reaction and purchase decision spatial heatmaps of the location.
